(19) United States
(12) Patent Application Publication
(10) Pub. No.: US 2010/0183820 A1
(43) Pub. Date: Jul. 22, 2010

(54) METHODS FOR CURING UV-CURABLE COATINGS

(75) Inventors: Christopher Seubert, Livonia, MI (US); Mark Edward Nichols, Saline, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/355,420

(22) Filed: Jan. 16, 2009

(51) Int. Cl. C08F 2/48

(52) U.S. Cl. 427/493

(57) ABSTRACT

According to at least one aspect of the present invention, a method is provided for curing a surface coating. In at least one embodiment, the method includes providing a substrate having an ultraviolet-curable coating thereon, the coating having a base temperature, heating the coating for a first period of time to an elevated temperature above the base temperature, and irradiating the coating with ultraviolet irradiation for a second time period, at least a portion of the first time period occurring simultaneously with the second time period.

### BACKGROUND OF THE INVENTION

1. Field of the Invention

At least one aspect of the present invention relates to a method for curing UV-curable coatings.

2. Background Art

One of the factors influencing a consumer's decision in purchasing a vehicle is the vehicle appearance. As such, the finishing or painting of a vehicle is an important aspect of the automotive process.

UV-curable coatings have been explored as an alternative low or zero VOC (volatile organic compound) coating technology. UV curing offers the advantages of, among other things, low or potentially zero VOC's, relatively very short (potentially only a few seconds) curing times, and relatively very high cross-link densities (given rise to outstanding scratch resistance). All of these properties are attractive to the automotive industry.

The main constituents of a UV-curable clearcoat include multifunctional oligomers, reactive diluents or monomers, photoinitiators and various light stabilizers. UV-curable clearcoats use free radical initiation as the mechanism of curing. Curing reactions are induced by absorption of UV light by the photoinitiator, and subsequent polymerization and cross-linking of the resins (oligomers and monomers).

The use of UV-induced curing also comes with limitations since high intensity UV lamps produce ozone which may be hazardous in a manufacturing environment. As such, there is a need in the art for a method of curing UV-curable compositions while the duration of UV-irradiation is effectively shortened or maintained at a minimum.

### SUMMARY

According to at least one aspect of the present invention, a method is provided for curing a surface coating. In at least one embodiment, the method includes providing a substrate having an ultraviolet-curable coating thereon, the coating having a base temperature, heating the coating for a first period of time to an elevated temperature above the base temperature, and irradiating the coating with ultraviolet irradiation for a second time period, at least a portion of the first time period occurring simultaneously with the second time period.

In at least another embodiment, the heating is carried out using infrared irradiation.

In at least yet another embodiment, the second time period is longer than the first time period. In at least one particular embodiment, the second time period starts before the first time period starts.

In at least yet another embodiment, the portion of the first time period occurring simultaneously with the second time period is a value of from 30 seconds to 3 minutes.

In at least yet another embodiment, the base temperature is between 20 to 25 degrees Celsius and the elevated temperature is between 50 to 85 degrees Celsius. In at least one particular embodiment, the coating is at least 90 percent cured after 5 minutes of subjecting the coating to the first and the second time periods, the time periods each being no greater than 5 minutes. In at least another particular embodiment, the coating is at least 90 percent cured after 3 minutes of subjecting the coating to the first and the second time periods, the time periods each being no greater than 3 minutes.

In at least yet another embodiment, the substrate comprises a motor vehicle.

### BRIEF DESCRIPTION OF THE FIGURES

FIG. 1 depicts an external portion of a motor vehicle being subjected to surface repair and refinish according at least one aspect of the present invention;

FIGS. 2A-2B depict a coating process wherein a UV-curable coating having a base temperature is subjected to a first UV irradiation having a first dose at a first elevated temperature effected by a first IR treatment and consecutively to a second UV irradiation having a second dose at a second elevated temperature effected by a second IR treatment according to at least one embodiment of the present invention;

FIGS. 3A-3B depict a coating process wherein a UV-curable coating having a base temperature is subjected to a first UV irradiation having a first dose at a first elevated temperature effected by a first IR treatment and consecutively to a second UV irradiation having a second dose according to at least one embodiment of the present invention; and

FIGS. 4A-4B depict a coating process wherein a UV-curable coating having a base temperature is subjected to a first UV irradiation having a first dose and consecutively to a second UV irradiation having a second dose at an elevated temperature effected by an IR treatment according to at least one embodiment of the present invention.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims indicating amounts of materials or conditions of reactions and/or use are to be understood as modified by the word “about” in describing the broadest scope of this invention. Practice within the numeral limit stated is generally preferred. Also, unless expressly stated to the contrary, percent, “parts of”, and ratio values are by weight and the description of a group or class of materials are suitable or preferred for a given purpose in connection with the invention implies that mixtures of any two or more members of the group or class may be equally suitable or preferred.

According to at least one aspect of the present invention, a method is provided for curing a surface coating on a substrate. In at least one embodiment, the method includes providing a substrate having an ultraviolet (UV)-curable coating thereon, the UV-curable coating having a base temperature, heating the UV-curable coating for a first period of time to an elevated temperature above the base temperature and irradidating the UV-curable coating to UV irradiation for a second time period, at least a portion of the first time period occurring simultaneously with the second time period. In at least one embodiment, the heating step is carried out with infrared irradiation. Other heating methods may also include microwave and convection.

Examples of suitable substrates include wood; glass; leather; plastics; metals, such as iron, steel, zinc, aluminum, titanium, and alloys thereof with one another or with other metals; minerals such as cement, clay, ceramic, natural stone, artificial stone; foams; fiber materials, such as glass fibers, ceramic fibers, carbon fibers, textile fibers, polymer fibers, metal fibers, or composite fibers; or substrates that have already been coated or primed, such as automobiles or automobile parts.

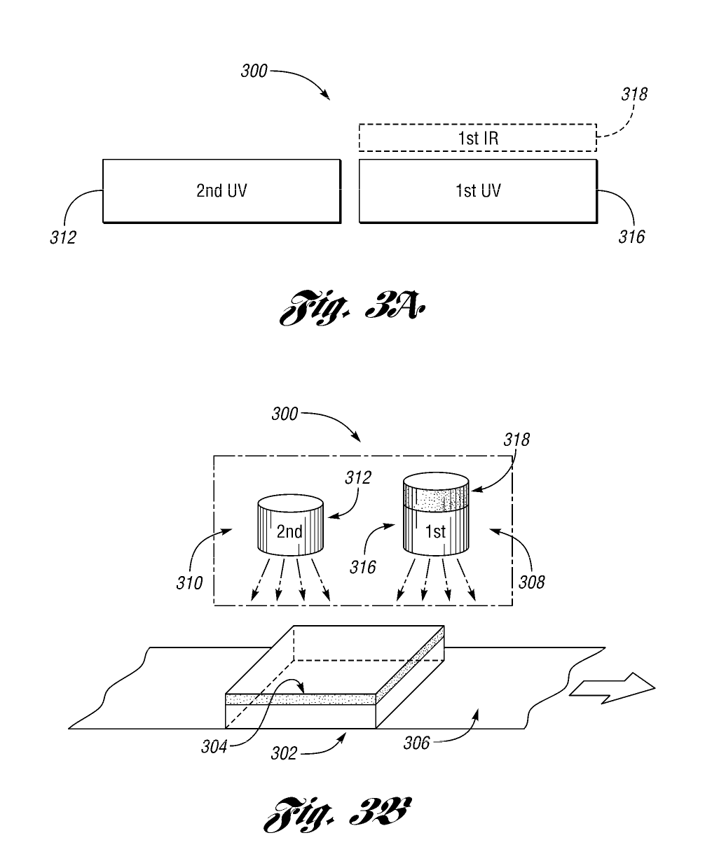

In at least one particular embodiment, and as depicted in FIG. 2A, a UV-curable coating having a base temperature, such as the UV-curable coating 204 shown in FIG. 2B, is subjected to a curing procedure generally shown at 200. The curing procedure 200 includes a first UV irradiation having a first dose at a first elevated temperature effected by a first IR irradiation 218 and a second UV irradiation 216 having a second dose at a second elevated temperature effected by a second IR irradiation 214. In the event that the first elevated temperature and the second elevated temperature are the same collectively as a single elevated temperature, the first IR and the second IR exposure may be consolidated and can be rendered by a single IR-generating equipment.

FIG. 2B illustrates the curing of the UV-curable coating 204 using the procedure depicted in FIG. 2A. As depicted in FIG. 2B, a substrate 202 having the UV-curable coating 204 thereon is transported via a conveyor 206 in the direction of arrow shown. During the conveyance, the UV-curable coating 204 is subjected to a first UV irradiation delivered by a first irradiation generator 208 and to a second UV irradiation delivered by a second irradiation generator 210, sequentially. The first irradiation generator 208 includes a UV irradiation module 216 and an IR exposure module 218 delivering irradiation and rays in respective dosage. Specific dosages of the UV irradiation module 216 or the IR exposure module 218 will be discussed in more detail herein elsewhere. Although the curing procedure 200 is depicted in FIGS. 2A-2B to be effectuated by separable irradiation generators 208 and 210, it is appreciated that the irradiation generators 208 and 210 may be arranged in an array format such that physical gap or time elapse exists between the generators 208 and 210.

The UV-curable coating according to embodiments of the present invention is comprised essentially of UV-curable compounds in contrast to thermal curable compounds. As such, the IR irradiation such as IR rays emitted from the IR modules 214 and 218 is not intended to effectuate additional curing but to potentiate and accelerate the curing delivered through the UV modules 212 and 216. Without being limited by any particular theories, one possible explanation may be that IR rays from the IR modules 214 and/or 218 effectuate an elevation of operating temperatures under which respective UV irradiation takes place. This thermal potentiation effect rendered by the IR modules 214 and/or 218 in relation to accelerating the UV curing advanced by the UV modules 216 and/or 212 is advantageous for an expedited curing process adapted to an in-line process as illustratively depicted in FIG. 2B.

Although depicted in FIGS. 2B to be in a cylindrical form, the first and the second irradiation generator 208 or 210 may take any shape. It is appreciated that a cross-section of the first and the second irradiation generator 208, 210 may take any suitable shape, such as the shape of a circle, a square, a rectangle, a triangle, or other shapes of a polygon. It is also appreciated that the UV module 212 (or 216) and the IR module 214 (or 218) may be arranged in any order, for instance they may be aligned vertically, laterally, or a mixture thereof. Moreover, each module 212, 214, 216, 218 may itself be an assembly of a number of irradiation light bulbs. The particular arrangement as to the light generators within each module or as to modules relative to each other within a particular generator 208, 210 is not critical for carrying out the present invention as long as certain specified irradiation dosage and irradiation temperature are satisfied per application.

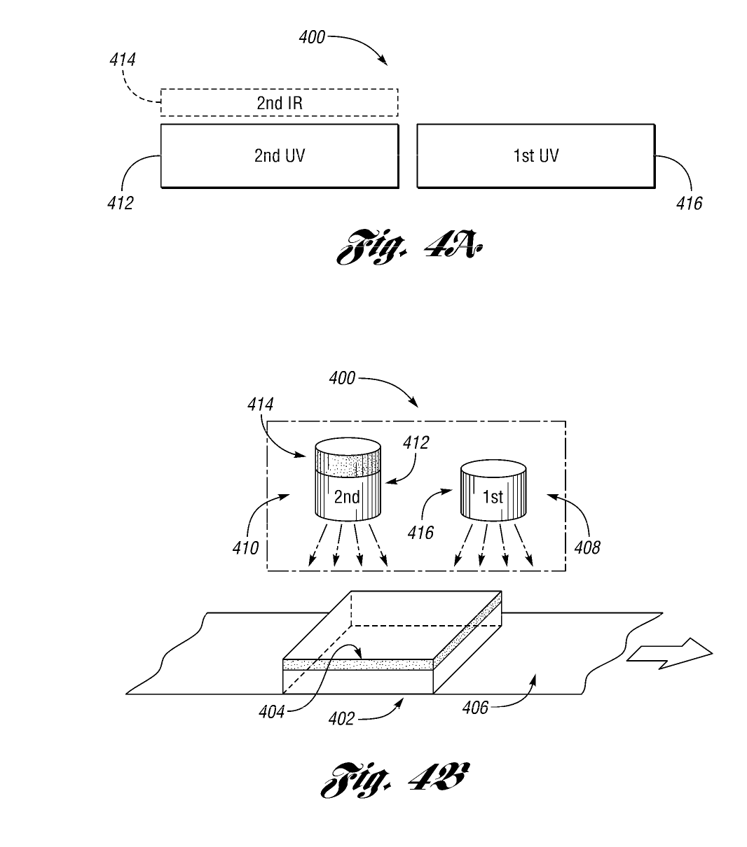

In at least another particular embodiment, and as depicted in FIG. 3A, a UV-curable coating of FIG. 3B having a base temperature is subjected to a curing procedure generally shown at 300. The curing procedure 300 includes a first UV irradiation step 316 having a first dose at a first elevated temperature effected by a first IR exposure 318 and a second UV irradiation step 312 having a second dose at a second elevated temperature. It is noted that in this embodiment, the second elevated temperature may be any temperature inherently derived from the application of the second UV irradiation step 312.

FIG. 3B illustrates the curing of the UV-curable coating 304 on a substrate 302 in an in-line process using the procedure depicted in FIG. 3A. As depicted in FIG. 3B, the UV-curable coating 304 having a base temperature, as applied onto the substrate 302, is transported via a conveyor 306 in the direction of arrow shown. During the conveyance, the UV-curable coating 304 is subjected to a first UV irradiation delivered by a first irradiation generator 308 and to a second UV irradiation delivered by a second irradiation generator 310, sequentially. The first irradiation generator 308 includes a UV irradiation module 316 and an IR exposure module 318 delivering irradiation and rays in respective dosage. Specific dosages of the UV irradiation module 316 or the IR exposure module 318 will be discussed in more detail below.

In at least yet another particular embodiment, and as depicted in FIG. 4A, a UV-curable coating 404 of FIG. 4B having a base temperature is subjected to a curing procedure generally shown at 400. The curing procedure 400 includes a first UV irradiation step 416 having a first dose at a first elevated temperature and a second UV irradiation step 412 having a second dose at a second elevated temperature effected by a second IR exposure 414. It is noted that in this embodiment, the first temperature may be same to the base temperature of the UV-curable coating 404 or any temperature inherent with the use of the first UV irradiation step 416.

FIG. 4B illustrates the curing of the UV-curable coating 404 on the substrate 402 in an in-line process using the procedure depicted in FIG. 4A. As depicted in FIG. 4B, the substrate 402 having the UV-curable coating 404 applied thereon is transported via a conveyor 406 in the direction of arrow shown. During the conveyance, the UV-curable coating 404 is subjected to a first UV irradiation delivered by a first irradiation generator 408 and to a second UV irradiation delivered by a second irradiation generator 410, sequentially. The first irradiation generator 408 includes a UV irradiation module 416 delivering UV rays in respective dosage. The second irradiation generator 410 includes a UV irradiation module 412 and an IR exposure module 414. Specific dosages of the UV irradiation modules 416 and 412 or the IR exposure module 414 will be discussed in more detail below.

In at least one embodiment such as the embodiments described herein, the base temperature of the UV-curable coating such as 204, 304, 404 can be of a value in a range of 18 to 30 degrees Celsius, or particularly of 20 to 25 degrees Celsius.

In at least one embodiment such as the embodiments described herein, the elevated temperature of the UV-curable coating such as 204, 304, 404 effectuated by the IR irradiation generator such as 218, 214, 318, 414, respectively, may be of a value in a range of 40 to 100 degrees Celsius, of 50 to 90 degrees Celsius, and particularly of 60 to 80 degrees Celsius, and more particularly of 45 to 70 degrees Celsius.

It has been found that the elevated temperature delivered by the heating step such as the IR exposure or a whole-vehicle oven detailed hereinafter, according to embodiments of the present invention, is in a range of relatively low values in degrees Celsius. In particular situations wherein the elevated temperature is in the range of 45 to 70 degrees Celsius, one skilled in the ordinary art would have not been encouraged or would have not thought of trying to couple this low temperature IR or oven exposure with an effort to expedite a UV curing process, since a heating temperature sometimes greater than 120 degrees Celsius is generally used to deliver thermal curing. When the thermal curing is coupled to a UV curing step, together they define what is known as the “dual curing” process wherein the high temperature thermal curing is merely to deliver “additional” curing but not to “expedite” the curing carried out with UV irradiation. As such, “dual curing” often fails to provide the benefit of shortened treatment time period that embodiments of the present invention can offer.

The first and the second UV irradiation may be carried out using light of a wavelength in a range of between 200 nanometers to about 600 nanometers, particularly of between 250 nanometers to about 500 nanometers, and more particularly of between 300 nanometers to about 450 nanometers. In certain particular instances, the first and the second UV irradiation is each carried out using light of UVA rays with a wavelength ranging from 300 to 400 nanometers as compared to UVB rays or UVC rays. The use of UVA rays having relatively longer wavelength, when coupled with the much shortened irradiation treatment period due to the synergistic collaboration afforded by the IR exposure according to embodiments of the present invention, provides an additional benefit in reducing or eliminating ozone production otherwise conventionally associated with the use of UV light.

The first and the second UV irradiation may be carried out using any suitable UV lamps as the light source. Both point sources and platform projectors such as lamp carpet may be used. The UV light sources illustratively include carbon arc lamps, xenon arc lamps, pressurized mercury lamps, metal halide lamps, microwave-excited metal-vapor lamps, excimer lamps, UV fluorescent lamps, argon filament lamps, electronic flash lamps, and photographic flood lights. The UV light sources such as the above-mentioned pressurized (high-, medium-, or low-) mercury vapor lamps may further be doped, for instance with lead, to open up a radiation window.

In the event when the substrate is of complex shape, as are envisaged for automobile bodies, having regions not accessible to direct radiation such as cavities, folds, and other structural undercuts. The coating material on the substrate may be cured using pointwise, small-area or all-round light sources in conjunction with an automatic movement device for the irradiation of cavities or edges.

The first dose and/or the second dose of the UV irradiation steps can be of any suitable dosage and can be the same. Selecting a suitable dosage for the first and/or the second dose may depend on several curing parameters involved, including among others curing duration, type of substrate surface, thickness of a resulting coating. In at least one particular embodiment, and as measured with a wavelength of between 320 to 390 nanometers, the first dose and the second dose are each independently a value in a range of 1 to 6×10⁴ J/m², in a range of 2×10³ to 5×10⁴ J/m², or in a range of 6×10³ to 4×10⁴ J/m².

A distance between the UV lamp and the coating to be irradiated may be of any suitable value and may vary depending on a particular dosing requirement. In general, the distance may be in a range of 2 centimeters to 150 centimeters, particularly of 10 centimeters to 120 centimeters, and more particularly of 20 centimeters to 100 centimeters.

In certain instances and as briefly mentioned above, the first UV irradiation and the second UV irradiation may be carried out consecutively and without any lapse of time there between. In certain other instances, however, a rest period can be imposed between the first UV irradiation and the second UV irradiation. Without intended to be limited by any theories, the rest period is used for leveling and devolatilizing any volatile constituents that may be present in the coating material. The rest period can be from 2 to 90 seconds, 5 to 80 seconds, 10 to 70 seconds, or 15 to 60 seconds. The rest period can further be accelerated by an elevated temperature. The elevated temperature may be effected by any thermal-inducing methods including those IR-generating methods discussed herein in relation to the first and the second UV irradiation.

Coupling of a heating step such as IR exposure with at least one of the UV irradiation steps, as contemplated according to the embodiments of the present invention, advantageously accelerates the respective UV irradiation treatment and hence renders surface coating processes more time and cost efficient. In certain particular instances, the first time period and the second time period can be rendered no greater than 10 minutes, particularly no greater than 7 minutes, more particularly no greater than 5 minutes, and even more particularly no greater than 3 minutes.

It is noted that according to embodiments of the present invention, beneficial effect of a heating step such as the IR exposure on the UV irradiation curing is not to induce additional new cured product, but simply to facilitate and in certain particular instance, to expedite the UV irradiation curing step. Contrary to some conventional methods, the IR exposure is not to change cross-linking density, neither does the IR exposure induce the formation of any end product that would otherwise not be produced by the UV irradiation alone.

The IR rays may include rays of different wavelengths, for instance short infrared rays and medium infrared rays. These infrared rays are optionally of the rapid type and featuring emission and extinction start times of less than one second. The short infrared rays may have a wavelength of the emission peak situated between 0.4 and 1.4 micrometers; and particularly between 0.8 and 1.1 micrometers. The medium infrared rays may have a wavelength of the emission peak situated between 1.4 and 3 micrometers; and particularly between 1.9 and 2.2 micrometers.

Materials for used in the UV-curable coatings in accordance with embodiments of the present invention are generally applied onto the substrate surface in a wet film, the curing of which results in a coating having thickness that is advantageous and/or necessary for its intended function. The coating thus cured can be of any suitable thickness dependent on particular applications involved. In certain instances, the coating in the cured form can have a thickness in a range selected from no less than 5, 10, 15, 20, 25, 30, 35, or 40 micrometers, to no greater than 100, 90, 80, 70, 60, or 50 micrometers.

The coating may be applied using coating methods illustratively including electrostatic coating and pneumatic spraying. Electrostatic coating may be carried out by means of an electrostatic spraying slot, an electrostatic spraying bell, or an electrostatic spraying disk. Alternatively, electrostatic coating may be carried out by means of electrostatically assisted mechanical atomization by means of electrostatic high-speed rotating disks or high-speed rotating bells. The pneumatic spraying may be carried out by hand or using customary and known automatic painting devices or painting robots.

The UV-curable coating contains UV-curable compounds having a concentration of at least 20%, 30%, 40%, 50%, 60%, 70%, 80%, or 90% by weight of solids, based upon the total solids in the UV-curable coating. In certain particular instances, the UV-curable coating may contain 100% UV-curable compounds by weight of solids.

The UV-curable compounds may contain chemical bonds that can be activated by UV irradiation. Such chemical bonds include single and/or double bonds between carbon and hydrogen, between carbon and carbon, between carbon and oxygen, between carbon and nitrogen, between carbon and phosphorus, and between carbon and silicon.

In certain particular instances, the UV-curable compounds each contain at least one carbon and carbon double bond. Suitable UV-curable component having at least one carbon and carbon double bond illustratively contains (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups, ethenylarylene ether, dicyclopentadienyl ether, norbornenyl ether, isoprenyl ether, isopropenyl ether, allyl ether or butenyl ether groups, or ethenylarylene ester, dicyclopentadienyl ester, norbornenyl ester, isoprenyl ester, isopropenyl ester, allyl ester or butenyl ester groups.

The UV-curable compounds for the UV-curable coating according to embodiments of the present invention may be selected from the following main categories: 1) free radical polymerized (meth)acrylate functionalized polymers, 2) Michael addition (meth)acrylate functionalized, 3) cationically polymerized epoxies, and 4) photolatent base thiols. (Meth)acrylate functionalized polymers generally comprise (meth)acrylate functional oligomers and monomers. These can be used alone with photoinitiators to facilitate free radical curing. They may also be incorporated with Michael additional chemistry donors, such as acetoacetate based compounds, and a photolatent base catalyst and crosslink upon UV exposure via Michael addition crosslinking. These (meth)acrylate functional oligomers are typically prepared by a) reaction of difunctional exposies with (meth)acrylic acid, b) the reaction product of difunctional isocyanates with hydroxyl functional (meth)acrylates, or c) the condensation product of (meth)acrylic acid and hydroxyl groups on a polyester backbone, or an hydroxyl(meth)acrylate with residual acid groups on a polyester backbone. (Meth)acrylate functionalized polymers include urethane acrylates, polyester acrylates, and epoxy acrylates. Cationic systems tend to be based on cycloaliphatic exposies and a photoinitiator which decomposes to give a “super” acid with UV radiation. The super acid catalyzes the cationic polymerization of the epoxy. Photolatent base thiol systems, similar to cationic systems, are initiated when photoinitiators decompose to form a catalyst. However, unlike cationic systems, these photolatent base systems create a “super” base. The super base catalyzes the epoxy-thiol or urethane-thiol crosslinking reaction.

The UV-curable coating also includes one or more photoinitiators to initiate free radical polymerization after irradiation with high-energy UV light. Examples include 2-hydroxyphenyl ketones such as 1-hydroxycyclohexyl-phenyl ketone; benzil ketals such as benzil dimethyl ketal; acylphosphine oxides such as bis-(2,4,6-trimethyl-benzoyl)phenylphosphine oxide; diacylphosphine oxides; benzophenone; and derivatives thereof.

The photoinitiator may be used individually or in combination, and may further be combined with accelerators or co-initiators.

The photoinitiators may be used in an amount in the range of 0.1 to 10 percent by weight, particularly 1 to 7 percent by weight, or more particularly 2 to 4 percent by weight, based on solids content of the coating material.

The photoinitiator absorb strongly in the UV range. In certain particular instances, the photoinitiators may also exhibit absorption in certain extended wavelengths up to 425 nanometers, 450 nanometers, 475 nanometers, or 505 nanometers. Affording absorption in these extended wavelength ranges enables the production of much thicker coatings than can be produced using photoinitiators absorbing in an isolated UV range.

The photoinitiators may contain any suitable photo-active compound, as long as the compound satisfies the wavelength response criteria, is compatible with the other components of the coating material, and does not lead to excessive vaporization.

The UV-curable coating may further include at least one or more color pigments illustratively including organic color pigments, inorganic color pigments, fluorescent pigments, electrically conductive pigments, and magnetically shielding pigments. The amount of the color pigments may vary widely and is guided by the requirements of the application in hand. Based on the solids of the coating material, the color pigments are used in an amount from 1 to 50 percent, 2 to 40 percent, 3 to 35 percent, 4 to 30 percent, or 5 to 25 percent, based in each instance on the dry solid weight of the coating.

Examples of suitable inorganic color pigments are white pigments such as titanium dioxide, zinc white, zinc sulfide or lithopone; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

Examples of fluorescent pigments (daylight-fluorescent pigments) are bis(azomethine) pigments.

Examples of suitable electrically conductive pigments are titanium dioxide/tin oxide pigments.

Examples of magnetically shielding pigments are pigments based on iron oxides or chromium dioxide.

The UV-curable coating may further include organic fillers, inorganic fillers, and/or tackifiers.

Examples of suitable organic and inorganic fillers are chalk, calcium sulfates, barium sulfate, silicates such as talc, mica or kaolin, silicas, oxides such as aluminum hydroxide or magnesium hydroxide, or organic fillers such as polymer powders, especially of polyamide or polyacrylonitrile.

The UV-curable coating may further include one or more tackifiers. In certain particular instances, the tackifiers are used in an amount of from 0.1 to 10% by weight, from 0.2 to 9% by weight, from 0.3 to 8% by weight, from 0.4 to 7% by weight, or from 0.5 to 6% by weight, based in each case on the solids of the coating material.

Examples of suitable tackifiers are highly flexible resins selected from the group consisting of homopolymers of alkyl (meth)acrylates, especially alkyl acrylates such as poly(isobutyl) acrylate or poly(2-ethylhexyl acrylate), which are sold under the brand name Acronal® by BASF Aktiengesellschaft, under the brand name Elvacite® by DuPont, under the brand name Ncocryls by Avccia, and as Plexigum® by Roehm; linear polyesters such as are commonly used for coil coating and are sold, for example, under the brand name Dynapol® by Dynamit Nobel, under the brand name Skybond® by SK Chemicals, Japan, or under the commercial designation LTW by Hüls; linear difunctional oligomers which are curable with actinic radiation and have a number-average molecular weight of more than 2000, in particular from 3000 to 4000, based on polycarbonatediol or polyesterdiol, which are sold under the designation CN 970 by Craynor or under the brand name Ebecryl® by UCB; linear vinyl ether homopolymers and copolymers based on ethyl, propyl, isobutyl, butyl and/or 2-ethylhexyl vinyl ether, which are sold under the band name Lutonal® by BASF Aktiengesellschaft; and nonreactive urethane-urea oligomers, which are prepared from bis(4,4-isocyanatophenyl)methane, N,N-dimethylethanolamine and diols such as propanediol, hexanediol or dimethylpentanediol and which are sold, for example, by Swift Reichold under the brand name Swift Range® or by Mictchem Chemicals under the brand names Surkopack® or Surkofilm®.

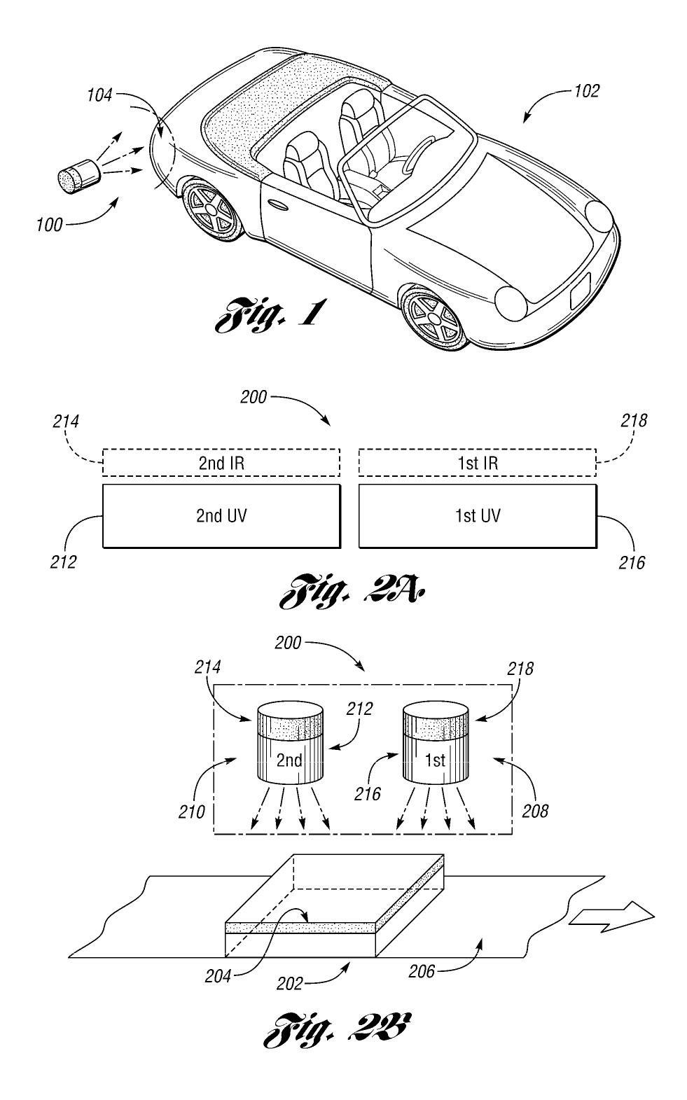

According to at least another aspect of the present invention, a method is provided to repair and refinish the surface of a body part of a motor vehicle. In at least one embodiment, and as illustratively depicted in FIG. 1, a body part 104 of a motor vehicle 102 is subjected to a generator assembly 100 for curing. The body part 104 has previously been sanded, vacuum cleaned, and applied with a repaint coating comprising essentially of UV-curable compounds as described herein. The treatment delivered by the generator assembly 100 may be substantially similar in relation to the irradiation treatment depicted in FIGS. 2B, 3B, and 4B. Since the thermal coupling effectively potentiates the speed and the extent of the UV curing process, the repaint coating (not shown) on the to-be-repaired surface part 104 may be effectively cured in a relatively short period of time before the part 104 is ready for sanding manually or by an orbital sanding machine.

The UV-curable coating according to embodiments of the present invention may itself be configured as a single layer coating or a multi-layer coating construction. The multi-layer coating construction may include primer, filler, clear lacquer, or any combinations thereof.

In certain particular instances where surface coating treatment on a whole vehicle is desired, the synergistic effect of the IR exposure on UV curing may be carried out through the use of a vehicle-accessible oven. Accordingly, a method may be provided for curing the surface coating of the entire vehicle. The method includes providing a motor vehicle having an UV-curable coating thereon, the UV-curable coating having a base temperature, heating the UV-curable coating in a vehicle-accessible oven for a first period of time to an elevated temperature above the base temperature, and irradiating the UV-curable coating with UV irradiation for a second time period, at least a portion of the first time period occurring simultaneously with the second time period. Under these circumstances, the operation temperature delivered by the vehicle-accessible oven is in a range of 35 to 100 degrees Celsius, 40 to 85 degrees Celsius, and more particularly 45 to 70 degrees Celsius.

According to embodiments of the present invention wherein a vehicle-accessible oven is used to synergize the UV curing, the UV curing light sources may be implemented within the oven. As such, a motor vehicle may be subjected to the elevated temperature delivered by the oven and the UV curing concurrently at least for a portion of the first time period and the second time period.

As used herein and unless otherwise noted, the term “vehicle-accessible oven” refers to an oven capable of enclosing at least one motor vehicle for subjecting the motor vehicle to an operating temperature as described herein.

As used herein and unless otherwise noted, the term “motor vehicle” may be any vehicle capable of holding 2, 4, 7, or more passengers and may be a passenger bus, a cargo transporting truck, or the like.

### EXAMPLE

An important aspect of coatings, particularly repair coatings, is that they must be sufficiently cured and hardened in order to allow for polishing with a polishing wheel by a repair technician. One potential repair system, provided by a paint supplier, is a thiol-urethane based clear coat. The clear coat can not be polished until approximately 15 to 30 minutes have passed at room temperature after the prescribed UV curing of 2 minutes in length. This delay of 15 to 30 minutes is much shortened when an IR irradiation step is coupled to the UV step such that the IR exposure and the UV irradiation are concurrently delivered for at least one minute of time. As it results, the delay in time before the polishing may be exerted is reduced to 1-3 minutes. In this particular example, the temperature of the supplied coating is increased from 20 degrees Celsius to about 60 degrees Celsius.

While the best mode for carrying out the invention has been described in detail, those familiar with the art to which this invention relates will recognize various alternative designs and embodiments for practicing the invention as defined by the following claims.

What is claimed:

1. A method for curing a surface coating comprising:
providing a substrate having an ultraviolet-curable coating thereon, the coating having a base temperature;
heating the coating for a first time period to an elevated temperature above the base temperature; and
irradiating the coating with ultraviolet irradiation for a second time period, at least a portion of the first time period occurring simultaneously with the second time period.

2. The method of claim 1, wherein the heating is carried out with infrared irradiation.

3. The method of claim 1, wherein the second time period is longer than the first time period.

4. The method of claim 3, wherein the second time period starts before the first time period starts.

5. The method of claim 1, wherein the portion of the first time period occurring simultaneously with the second time period is a value of from 30 seconds to 3 minutes.

6. The method of claim 1, wherein the base temperature is between 20 to 25 degrees Celsius and the elevated temperature is between 45 to 70 degrees Celsius.

7. The method of claim 6, wherein the coating is at least 90 percent cured after 5 minutes of subjecting the coating to the first and the second time periods, the time periods each being no greater than 5 minutes.

8. The method of claim 1, wherein the ultraviolet irradiation is carried out with light of a wavelength ranging from 300 to 400 nanometers to facilitate the effective reduction of ozone production.

9. The method of claim 1, wherein the substrate comprises a motor vehicle.

10. A method for curing a surface coating on a motor vehicle, the method comprising:
providing a motor vehicle having an ultraviolet-curable coating thereon, the coating having a base temperature;
heating the coating for a first period of time to an elevated temperature above the base temperature; and
irradiating the coating with ultraviolet irradiation for a second time period, at least a portion of the first time period occurring simultaneously with the second time period.

11. The method of claim 10, wherein the heating is carried out with infrared irradiation.

12. The method of claim 10, wherein the second time period is longer than the first time period.

13. The method of claim 12, wherein the second time period starts before the first time period starts.

14. The method of claim 10, wherein the portion of the first time period occurring simultaneously with the second time period is a value of from 30 seconds to 3 minutes.

15. The method of claim 10, wherein the base temperature is between 20 to 25 degrees Celsius and the elevated temperature is between 45 to 70 degrees Celsius.

16. The method of claim 15, wherein the coating is at least 90 percent cured after 5 minutes of subjecting the coating to the first and the second time periods, the time periods each being no greater than 5 minutes.

17. The method of claim 15, wherein the coating is at least 90 percent cured after 3 minutes of subjecting the coating to the first and the second time periods, the time periods each being no greater than 3 minutes.

18. A method for curing a surface coating on a motor vehicle, the method comprising:
providing a motor vehicle having an ultraviolet-curable coating thereon, the coating having a base temperature;
heating the motor vehicle in a vehicle-accessible oven for a first period to an elevated temperature above the base temperature; and
irradiating the coating to ultraviolet irradiation for a second time period, at least a portion of the first time period occurring simultaneously with the second time period.

19. The method of claim 18, wherein the elevated temperature is in a range of 45 to 70 degrees Celsius.

20. The method of claim 18, wherein the portion of the first time period occurring simultaneously with the second time period is a value of from 30 seconds to 3 minutes.
